(19) United States
(12) Patent Application Publication
(10) Pub. No.: US 2005/0021381 A1
(43) Pub. Date: Jan. 27, 2005

(54) Budget consistency checks for computerized financial management system

(76) Inventors: Horst Schnoerer, Angelbachtal (DE); Andreas Schaefer, Mougins (FR); Thomas M. Schaub, Antibes (FR); Herve Bourne, Le Cannet (FR)

Correspondence Address: KENYON & KENYON, 1500 K STREET, N.W., SUITE 700, WASHINGTON, DC, 20005, US

(21) Appl. No.: 10/669,369

(22) Filed: Sep. 25, 2003

Related U.S. Application Data
(60) Provisional application No. 60/488,814, filed on Jul. 22, 2003.

(51) Int. Cl. G06F 17/60

(52) U.S. Cl. 705/7

(57) ABSTRACT

A budgetary consistency check system is described, which operates on a working budget and a reference budget in respective databases, for performing budgetary consistency checks between arbitrary aggregation levels of an organization. Rules define relationships that must be maintained between the reference budget and the working budget. As modifications are made to the budgets, the rules may be executed online to determine whether the two budgets remain consistent with each other.

### BACKGROUND

In many organizations, particularly public sector organizations, the organization's budget may be determined by forces that are independent of the organization's expected funding in a given fiscal year. Governmental agencies provide an example of such organizations. In the United States, for example, different agency budgets may be established by an act of the U.S. Congress. The agencies themselves may have some discretion to develop budgets within their own organization subject, however, to limits expressly defined by the Congress. The agencies, of course, often develop and fund programs according to their own priorities that may or may not be consistent with the budget handed down by Congress. Accordingly, instead of developing its budget in a top down manner, the organization may develop a plurality of budgets independently, each budget relating to different units of the organization and at different levels of the company. Later, there is an attempt to integrate the subordinate budgets into a unitary whole and to check if the integrated budget is consistent with the master budget. In complicated organizations, with possibly thousands of different elements in its overall budget, it becomes administratively difficult to determine whether budgets from sub-elements of the organization are consistent with the master budget.

Accordingly, there is a need in financial management systems for a budget control system that determines whether proposed budget elements are consistent with requirements made for the budget.

### BRIEF DESCRIPTION OF THE DRAWINGS

FIG. 1 is a block diagram of a budgetary consistency check system according to an embodiment of the present invention.

FIG. 2 illustrates a rule array according to an embodiment of the present invention.

FIGS. 3(a)-(c) illustrate examples of reference budget data structure and working budget data structure according to an embodiment of the present invention.

FIG. 4 illustrates a budget data structure according to an embodiment of the present invention.

FIG. 5 illustrates a rule array according to an embodiment of the present invention.

FIG. 6 illustrates a rule array according to another embodiment of the present invention.

FIG. 7 illustrates a method according to an embodiment of the present invention.

FIG. 8 illustrates a computer system according to an embodiment of the present invention.

### DETAILED DESCRIPTION

Embodiments of the present invention provide techniques for performing budgetary consistency checks within a computerized financial management system. In such embodiments, first and second storage areas within a database system may store “working” budget values and “reference” budget values respectively. A working budget database may store financial values that are to be entered or amended. A reference budget database may store a second set of financial values that are to be compared to the working budget values to determine whether the entries of the working budget are permissible. The financial management system also may include a rule manager that stores rules that define the requirements.

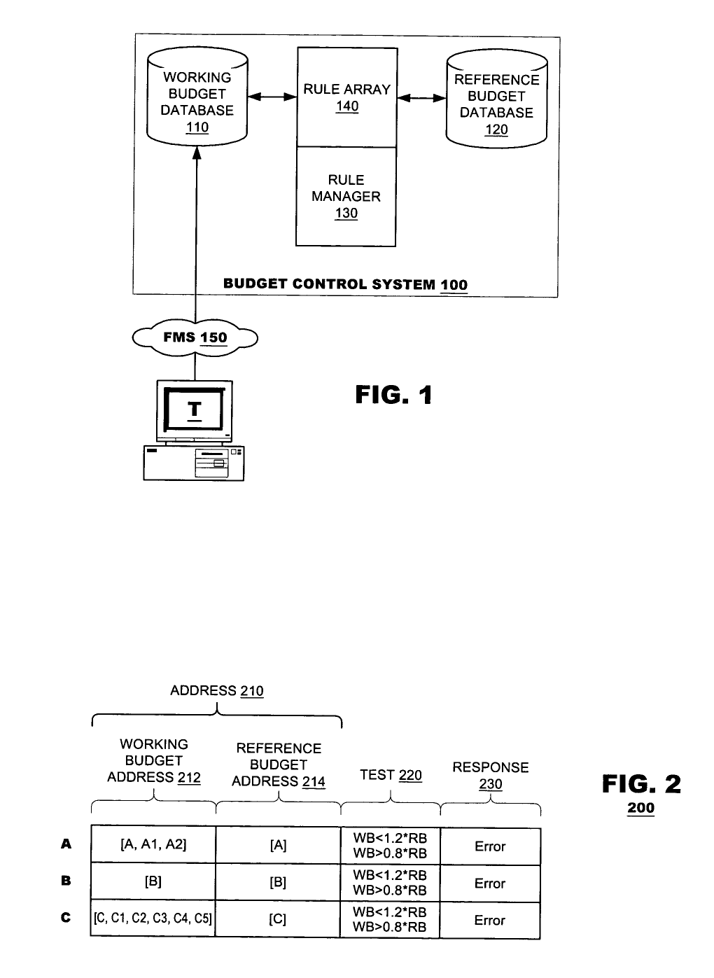

FIG. 1 is a block diagram of a budget control system 100 according to an embodiment of the present invention. The budget control system 100 includes a database system which includes a first database 110 for the working budget and a second database 120 for the reference budget. Herein, reference to “databases” merely connotes logically separate areas of a storage system; it is immaterial, for example, whether the working and reference budgets are provided in physically separate database systems or are merely different portions of a single database system. It is sufficient, for the purposes of the present discussion, to note that the working budget information and the reference budget information are maintained as separate entities and entries in each can be individually addressed.

The budget control system 100 also includes a rule manager 130. The rule manager executes rules, which are maintained in a rule array 140, to determine whether information in the working budget is consistent with the reference budget. The rules also define possible responses to actions performed on the working budget that do not satisfy the requirements of a particular rule.

In embodiments, the budget control system 100 may be provided as a component of a larger financial management system 150. As part of the functionality of the financial management system 150, operators at terminals T may create budget items that cause budget values to be stored or changed in the working budget database 110.

FIG. 2 illustrates a rule array 200 according to an embodiment of the present invention. As illustrated, each rule may include an address field 210 that includes a set of working budget addresses 212 and a set of reference budget addresses 214. These addresses act as pointers to locations within the respective budget databases from which budget values may be obtained. Addressed data from within the working budget database and the reference budget database are aggregated according to specific definitions in the rule, which may be provided in a separate definition field (not shown). The resulting aggregated values may be considered the operands of a particular rule. Each rule also may include a test field 220, which identifies the relationships between the working budget data and the reference budget data that must be satisfied to satisfy the rule. Additionally, each rule may include a response field 230, in which possible responses are identified when the test relationship is not satisfied.

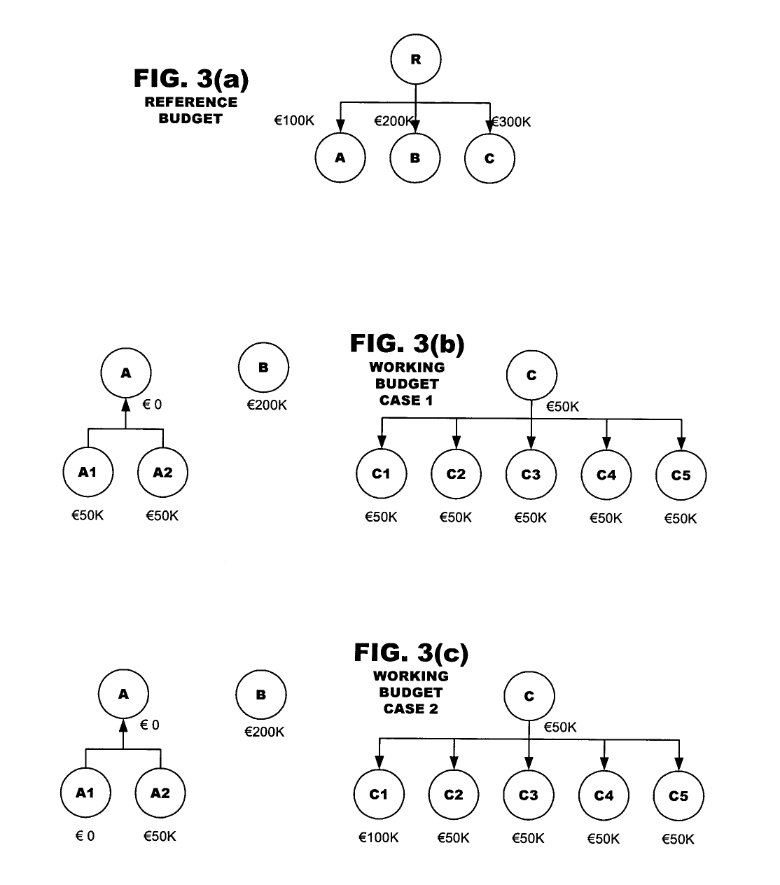

To facilitate the present discussion, exemplary rules are identified in FIG. 2 for budget data structures illustrated in FIGS. 3(a) and 3(b). Consider a hypothetical organization that includes departments A, B and C. Department A has been assigned a budget of [symbol] 100K. Department B has been assigned a budget of [symbol] 200K. Department C has been assigned a budget of [symbol] 300K. For the sake of discussion, it may be assumed that department A includes sub-departments A1 and A2, department B has no sub-departments and department C includes sub-departments C1, C2, C3, C4 and C5.

FIG. 3(a) illustrates a structure for a reference budget database that may be used to represent the budget data structure of the organization. The budget data structure may include nodes for each of the departments A, B and C. Each node may store budget values that have been assigned to each department (e.g., [symbol] 100K for department A, [symbol] 200K for department B and [symbol] 300K for department C). Optionally, the reference budget database structure also may include nodes for each department in an organization, even if those nodes do not have reference budget data associated therewith. Thus, if department A includes subordinate organizations A1 and A2, additional nodes (not shown) may be provided to reflect budget data associated with those organizations.

Three rules are illustrated in the exemplary rule array of FIG. 2. For department A, the working budget addresses 212 point to nodes A, A1 and A2 of a working budget data structure and the reference address 214 points to node A of the reference budget data structure. The test field 220 specifies that the aggregated working budget values must be between 80% and 120% of the aggregated reference budget value. The rule for department B includes working budget and reference budget addresses that point to node B of the respective budget data structure and include the same test definition as for rule A. The rule for department C includes working budget addresses that point to node C and the subordinate nodes C1-C5 of the working budget data structure, a reference budget address that points to node C of the reference budget data structure and the same test relationship.

FIGS. 3(b) and 3(c) illustrate a structure for a working budget database under two different scenarios. In each case, the working budget is populated by nodes representing departments A, B and C and also representing sub-departments A1-A2 and C1-C5. Budget values have been assigned as follows:

TABLE 1
BUDGET VALUES

| | CASE I | CASE II |
|---|---|---|
| NODE | [FIG. 3(B)] | [FIG. 3(C)] |
| A | [symbol] 0 | [symbol] 0 |
| A1 | [symbol] 50K | [symbol] 0K |
| A2 | [symbol] 50K | [symbol] 50K |
| B | [symbol] 200K | [symbol] 200K |
| C | [symbol] 50K | [symbol] 50K |
| C1 | [symbol] 50K | [symbol] 100K |
| C2 | [symbol] 50K | [symbol] 50K |
| C3 | [symbol] 50K | [symbol] 50K |
| C4 | [symbol] 50K | [symbol] 50K |
| C5 | [symbol] 50K | [symbol] 50K |

If the rule array of FIG. 2 were executed using the working budget values of Case I and the reference budget values of FIG. 3(a), there would be no error. Executing the rule array would yield:

TABLE 2

| | SUM | | | |
|---|---|---|---|---|
| | OF WORKING | REFERENCE | | |
| | BUDGET | BUDGET | RATIO OF | |
| RULE | ENTRIES | VALUE | WB TO RB | RESPONSE |
| A | [symbol] 100K | [symbol] 100K | 1.0 | No error |
| B | [symbol] 200K | [symbol] 200K | 1.0 | No error |
| C | [symbol] 300K | [symbol] 300K | 1.0 | No error |

By contrast, if the rule array of FIG. 2 were executed using the working budget values of Case II and the reference budget values of FIG. 3(a), an error would be identified. Executing the rule array in this scenario would yield:

TABLE 3

| | SUM | | | |
|---|---|---|---|---|
| | OF WORKING | REFERENCE | | |
| | BUDGET | BUDGET | RATIO OF | |
| RULE | ENTRIES | VALUE | WB TO RB | RESPONSE |
| A | [symbol] 50K | [symbol] 100K | 0.5 | ERROR |
| B | [symbol] 200K | [symbol] 200K | 1.0 | No error |
| C | [symbol] 350K | [symbol] 300K | 1.167 | No error |

With respect to department A, the aggregate working budget would fall below 80% of the reference budget value for that department. Therefore, the rule for node A would be violated.

Although the foregoing example illustrates the consistency check as being performed following a definition or re-definition of working budget values, this need not be the case. Consistency checks may occur following a definition or re-definition of values in the reference budget or, of course, definition or re-definition of the test fields of the rules.

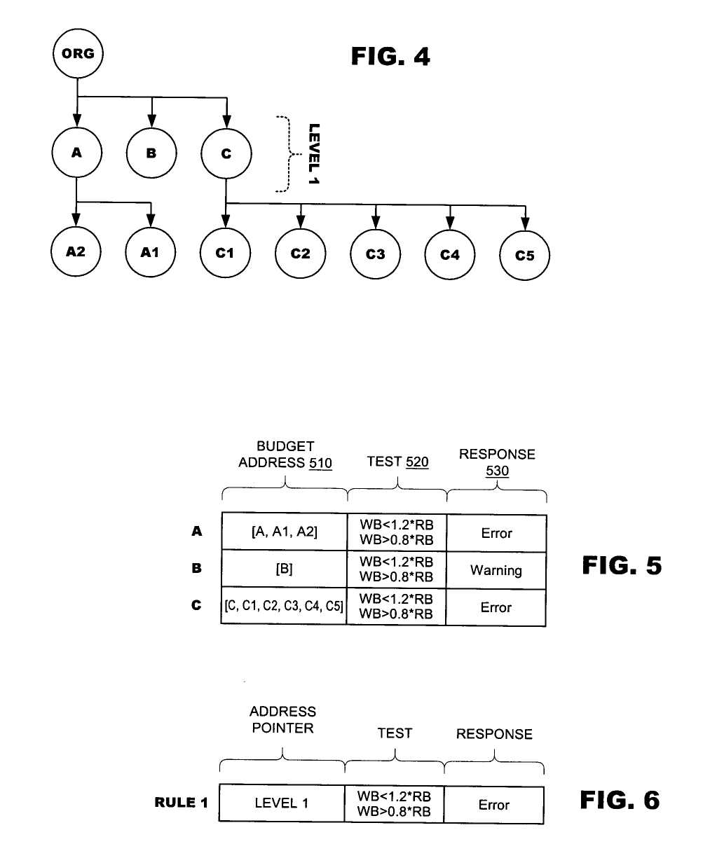

Although the working budget data structures and reference budget data structure are illustrated in FIGS. 3(a) and 3(b) as having different structures, this need not be the case. In one embodiment, the both budget data structures may have an identical structure. Continuing with the foregoing examples, the working budget data structure and the reference budget data structure each may have a structure as illustrated in FIG. 4. Although nodes would be provided, in this embodiment, for every possible budget entry (e.g., A, A1, A2, . . . ), there would be no requirement that each node be populated with budget information. So, if a reference budget does not specify a budget requirement for node A1, for example, it would be sufficient to provide a corresponding node in the reference budget data structure but to leave it empty of budget information.

Such embodiments can lead to a simplification in the rule array. Rather than provide separate address pointers 212, 214 to the reference budget database and to the working budget database, it could be sufficient to provide a single address field 510 in each rule, as illustrated in FIG. 5. During execution, the address pointer would be applied to the working budget database to retrieve working budget values and also would be applied to the reference budget database to retrieve reference budget values.

In another embodiment, where there is a large amount of redundancy among the various rules, a rule array may include smaller set of rules than tests to be applied. In this embodiment, illustrated in FIG. 6, a rule array may provide a rule that includes an address pointer, a test field and a response. The address pointer may indicate several sets of nodes in the budget data structure on which the test is to be applied recursively. Referring to the budget data structure of FIG. 4, for example, nodes A, B and C may be defined as appearing in a certain level of the database (called, “level 1”). There may be a single rule defined for the entire level. During execution, the rule manager may apply the test for each node in the specified level.

The embodiment of FIG. 6 is particularly appropriate where the budget structure include structural information that identify subordinate relationships among the nodes. For example, if the budget data structure itself includes information that identify nodes A1 and A2 as members of node A, then express pointers need not be provided in the rule array to link nodes A, A1 and A2. In this embodiment, when determining for example, an aggregate working budget for node A, a rule manager may trace along the structural information in the working budget data structure to identify all subordinate nodes (nodes A1, A2 and any nodes subordinate to them) and sum the working budget values associated with these nodes.

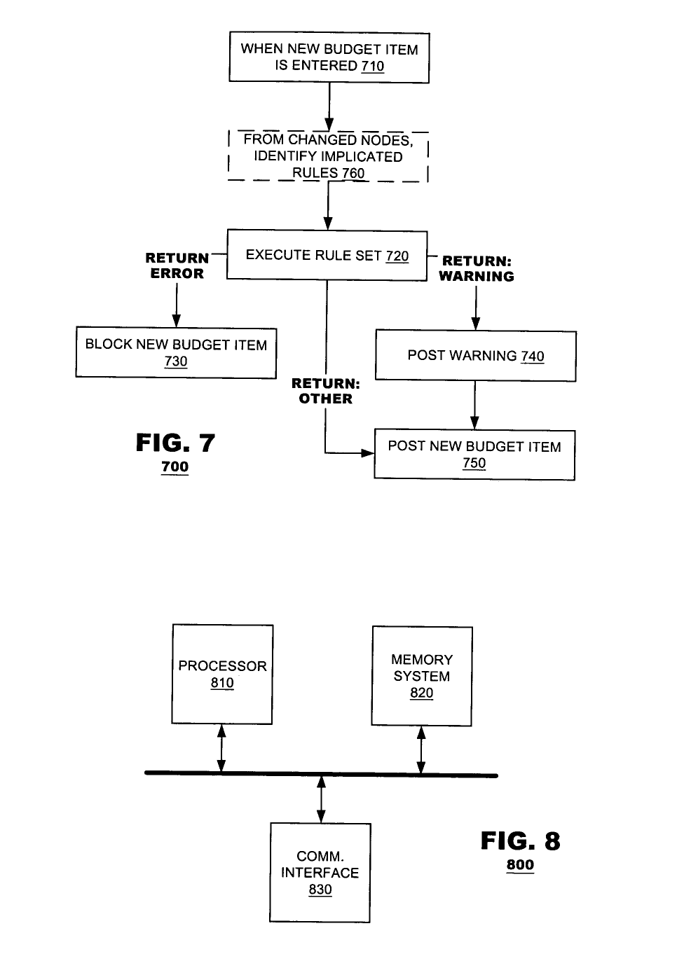

FIG. 7 illustrates a method 700 according to an embodiment of the present invention. The method may be invoked when the operator submits a transaction to the financial management system that either enters new budget information or transfers budget values among nodes in the database (box 710). When the new budget item is entered, the system may execute the rule array (box 720). Execution of each rule may cause an error to be generated, a warning to be generated or no response. If any rule returns an error, the new budget item may be blocked from the working budget database (box 730); the system will prevent it from being entered. If a rule returns a warning, the system may post a warning according to parameters provided in the rule (box 740). The system also may permit the new budget item to be entered in the working budget database (box 750). Of course, if no rule generates an error or a warning, the new budget item may be entered in the working budget database.

In many instances, a new budget item will cause new values to be stored in only one or a limited number of nodes of a working database. In one embodiment, the system may review the new budget item to determine which nodes of the working budget database would be affected if it were entered. The system then can select and execute only a subset of rules that apply to the identified nodes to determine whether the budget item can be admitted to the working budget database (box 760).

The methods illustrated in the foregoing embodiments provide a tool that permits an automated consistency check to be performed. The consistency check techniques can identify rule violations in a near real-time fashion which permits development of an on-line check system. As an operator, for example, edits budgetary values in a working budget, the check system can validate or reject various modifications.

The foregoing examples have described rules that, by and large, operate on common levels within a budget data structure. The invention, of course, is not so limited. One advantage of the present invention is that it is possible to define rules that are directed to vastly different layers and entries within a budget data structure. Thus, the rule array can be applied to budget data structures having several tens or several hundreds of layers of nodes with equal ease.

The foregoing description has illustrated exemplary reference budget data structures and working budget data structures. These budget structures were broken down only into departments and sub-departments within an organization. Of course, the budget databases of modern financial control systems are not so limited. So, for a particular node (say, node A), subordinate nodes may be organized according to other classifications beyond departmental divisions. Within node A, subordinate nodes may be provided which also reflect, for example, the functional purpose of an expenditure (e.g., salary, supply costs), budgeting sources or a long-term project. For the purposes of the present discussion, the particular classifications that are present in the reference budget or working budget databases are immaterial to the embodiments discussed above.

The budgetary control system of the foregoing embodiments, of course, may be embodied in a computer, a server or a network of servers. FIG. 8 is a simplified block diagram of such apparatus, which will include one or more processors 810, a memory system 820 and a communication interface 830. Processors 810, as is well known, execute program instructions and operate upon stored data. The memory system 820 is an abstraction of one or more electrical, magnetic or optical storage systems. The memory system 820 may include not only the working and reference budget databases and rule arrays as described above but also executable program instructions that, when executed, cause the methods of the foregoing embodiments to be performed. The communication interface may provide inter-network communication for the budgetary control system and enable communication with operator terminals (such as terminal T).

Several embodiments of the present invention are specifically illustrated and described herein. However, it will be appreciated that modifications and variations of the present invention are covered by the above teachings and within the purview of the appended claims without departing from the spirit and intended scope of the invention.

1. A financial management system, comprising:
a first data structure to store data representing a reference budget,
a second data structure to store data representing a working budget,
a rule array to store rules, each rule having an address field, a test field defining relationships between values of the reference budget and the working budget, and a response field.

2. The financial management system of claim 1, wherein the address field comprises:
a first address pointer addressing nodes of the working budget database, and
a second address pointer addressing nodes of the reference budget database.

3. The financial management system of claim 1, wherein the address field comprises a single address pointer referencing nodes of both the working budget database and the reference budget database.

4. The financial management system of claim 1, wherein the rule array includes a rule to be applied recursively to several sets of nodes from the working budget database and the reference budget database.

5. A method of performing budgetary consistency checks between a working budget database and a reference budget database, comprising:
receiving a budget item for entry into the working budget database,
executing one or more rules, the rules including pointers to entries within the working budget database and the reference budget database, a definition of a test relationship that must be satisfied to satisfy the rule and a definition of a response to be made when the test relationship is not satisfied,
if any rule generates an error, blocking the budget item from the working budget database.

6. This method of claim 5, further comprising, pursuant to execution of a rule, performing aggregation of addressed entries of the working database according to a definition provided in the rule, an aggregate value obtained therefrom being used to determine if the test relationship is satisfied.

7. The method of claim 5, further comprising pursuant to execution of a rule, performing aggregation of addressed entries of the reference database, according to a definition provided in the rule, an aggregate value obtained therefrom being used to determine if the test relationship is satisfied.

8. The method of claim 5, further comprising, if any rule generates a warning, posting an alert as specified in the response definition of the corresponding rule.

9. The method of claim 5, further comprising:
identifying elements within the working budget database that are to be changed by the new budget item, and
identifying rules for which the identified elements are operands,
wherein the executing causes only the identified rules to be executed.

10. A rule array for a budgetary check system, comprising a plurality of rules, each rule comprising:
an address field identifying locations from a first and second budget database from which budget value information is to be obtained,
a test field to store a definition of a relationship that must be met between values from the first data structure and values from the second data structure to satisfy the rule, and
a response field to store a definition of an action to occur if the relationship is not satisfied.

11. The rule array of claim 10, wherein the address field comprises:
a first address pointer addressing nodes of the first budget database, and
a second address pointer addressing nodes of the reference budget database.

12. The rule array of claim 10, wherein the address field comprises a single address pointer referencing nodes of both the first and second budget database.

13. The rule array of claim 10, wherein at least one rule contains an indication that it is to be applied recursively across a plurality of sets of locations of the first and second budget database, and the address field identifies the sets of locations.

14. The rule array of claim 10, at least one rule further comprising a field for definition of an aggregation rule to be applied to the locations specified in the respective address field.

15. A computer readable medium in which are stored program instructions that when executed, cause a financial management system to:
receive a budget item for entry into the working budget database,
execute one or more rules, the rules including pointers to entries within the working budget database and the reference budget database, a definition of a test relationship that must be satisfied to satisfy the rule and a definition of a response to be made when the test relationship is not satisfied,
if any rule generates an error, block the budget item from the working budget database.

16. The computer readable medium of claim 14, wherein the program instructions further cause the financial management system, if any rule generates a warning, to post an alert as specified in the response definition of the corresponding rule.

17. The computer readable medium of claim 14, wherein the program instructions further cause the financial management system to:
identify elements within the working budget database that are to be changed by the new budget item, and
identify rules for which the identified elements are operands, and
execute only the identified rules.
